(19) United States
(12) Patent Application Publication
(10) Pub. No.: US 2009/0280294 A1
(43) Pub. Date: Nov. 12, 2009

(54) PANEL STRUCTURE AND RELATIVE PROCESS FOR MAKING IT

(76) Inventor: Alfonso Branca, Milano (IT)

Correspondence Address: GOTTLIEB RACKMAN & REISMAN PC, 270 MADISON AVENUE, 8TH FLOOR, NEW YORK, NY, 10016-0601, US

(21) Appl. No.: 11/814,702

(22) PCT Filed: Jan. 24, 2006
(86) PCT No.: PCT/EP2006/000594

§ 371 Date: Jul. 25, 2007

(30) Foreign Application Priority Data
Jan. 28, 2005 (IT) MI2005A000119

(51) Int. Cl. B32B 3/24; B32B 27/00; B05D 7/22

(52) U.S. Cl. 428/138; 428/131; 427/181

(57) ABSTRACT

Through at least part or all of the thickness of the panel a plurality of channels extends in which there are structural stiffening elements comprising a resin-based material.

The present invention refers to a panel structure and to a process for making it.

For some time panels have been present on the market having sheets of composite material that give high resistance to the overall structure.

Reinforcement sheets made from composite material, consisting of a resin-based matrix in which a fibrous phase is dispersed, is particularly advantageous due to the high ratio between mechanical strength and weight, and can thus have various applications in different technological fields, from the building trade to the transport sector, etc.

Such a panel structure can nevertheless suffer from various drawbacks due above all to not always being able to optimally resist delamination between core and outer reinforcement sheets, and to not always being able to withstand mechanical stresses above all in the direction perpendicular to the main plane on which it lies.

In order to at least partially overcome these drawbacks it has been proposed to fixedly join together the reinforcement sheets with a sewing operation carried out through the core of the structure, but such a method is extremely laborious and burdensome in terms of time and therefore is also expensive and not very productive.

The technical task proposed of the present invention is, therefore, that of making a process for making a panel structure and a process for making it that allow the aforementioned technical drawbacks of the prior art to be eliminated.

In this technical task a purpose of the invention is that of making a panel structure that has an optimal capability to resist delamination and/or mechanical stresses in the direction perpendicular to the plane on which it lies.

Another purpose of the invention is that of making a panel structure that is extremely simplified and light but at the same time mechanically strong.

Another purpose of the invention is that of making a simple, extremely versatile and highly productive process for making a reinforced panel structure.

The technical task, as well as these and other purposes, according to the present invention, are accomplished by making a panel structure, characterised in that through at least part or all of its thickness a plurality of channels extend in which there are structural stiffening elements comprising a resin-based material.

Further characteristics and advantages of the invention shall become clearer from the description of preferred but not exclusive embodiments of the panel structure according to the finding, illustrated for indicating and not limiting purposes

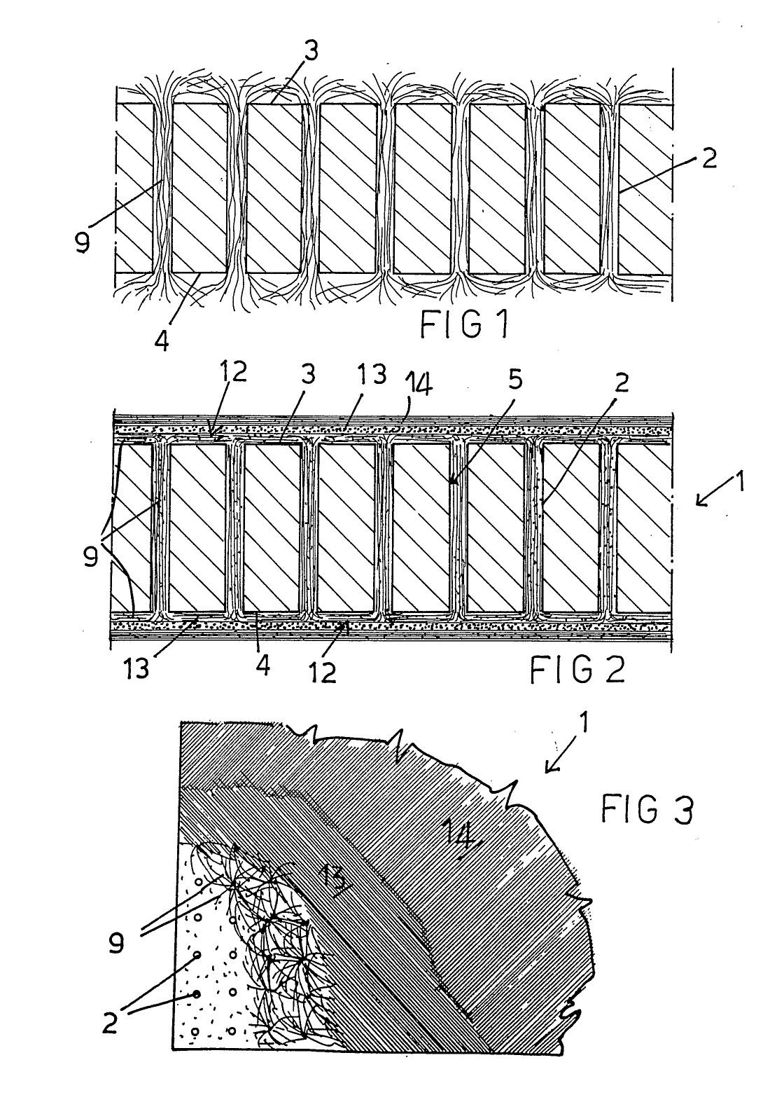

FIG. 1 shows a schematic top side view of a portion of the panel structure in accordance with a first preferred embodiment of the invention, after the first plurality of continuous fibres has been positioned in the channels but before the second plurality of fibres has been positioned, and before impregnation with resin;

FIG. 2 shows a schematic top side view of the panel structure of FIG. 1 after the application of the second plurality of fibres and after impregnation with resin;

FIG. 3 shows a plan view of the panel structure of FIG. 2 in which the layers of longitudinal fibres on the surface of the panel have been partially removed;

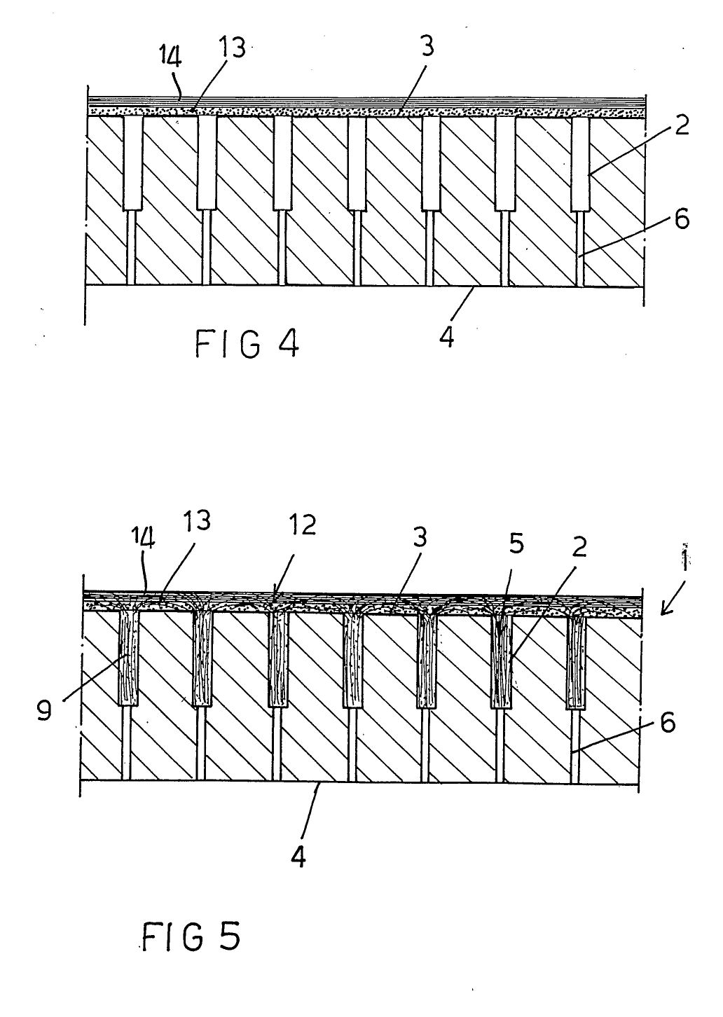

FIG. 4 shows a schematic top side view of a portion of the panel structure in accordance with a second preferred embodiment of the invention, after the second plurality of fibres has been positioned, but before the first plurality of fibres has been positioned, and before impregnation with resin;

FIG. 5. shows a schematic top side view of the panel structure of FIG. 4 after the application of the first plurality of fibres and after impregnation with resin;

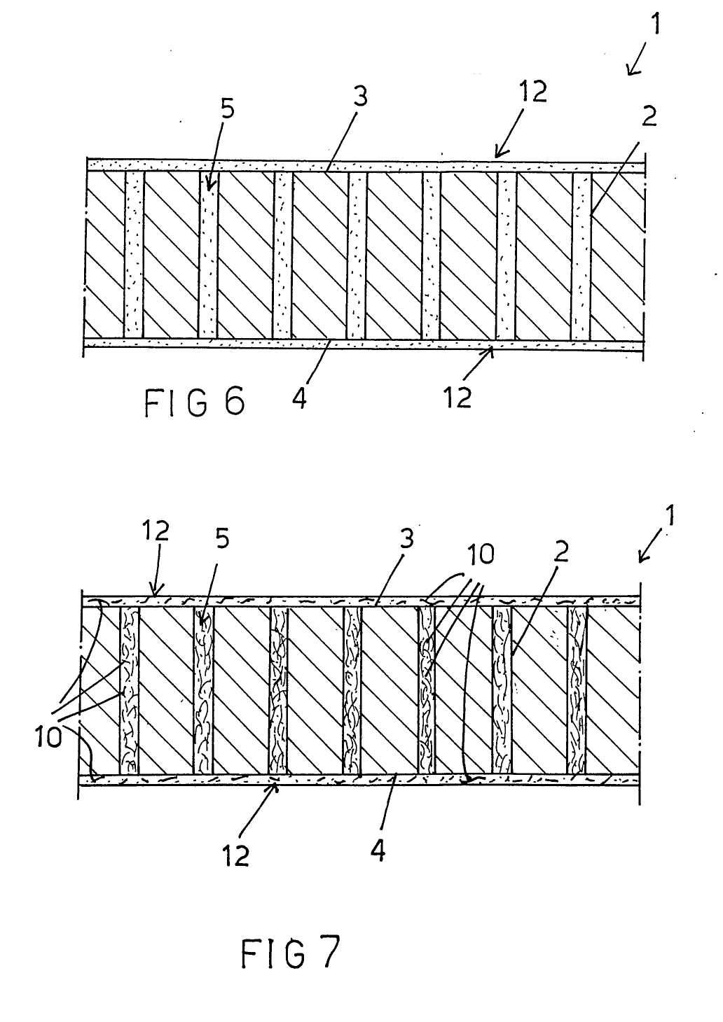

FIG. 6 shows a schematic top side view of a portion of the panel structure in accordance with a fourth preferred embodiment of the invention, in which a resin-based material that is not loaded impregnates the channels and goes in layered form on the opposite faces of the panel in which the channels flow; and

FIG. 7 shows a schematic top side view of a portion of the panel structure in accordance with a third preferred embodiment of the invention, in which a resin-based material loaded with discontinuous fibres impregnates the channels and goes in layered form on the opposite faces of the panel in which the channels flow.

With reference to the quoted figures, a panel structure is shown wholly indicated with reference numeral 1.

The panel 1 has a plurality of channels 2 that extend through at least part or all of its thickness.

The channels 2 preferably flow on at least one of two opposite faces 3, 4 of the panel 1, in particular on at least one of the two opposite faces that define its thickness. In the channels 2 there are structural stiffening elements 5 comprising a resin-based material.

The channels 2 preferably extend perpendicular to such opposite faces 3, 4 of the panel 1, and can be uniformly distributed on a defined part of the panel 1 or even on the entire panel 1.

However, the channels 2 can also have a different inclination or a different combination of inclinations to allow the structural stiffening elements 5 to be arranged according to a lattice design.

Preferably, the resin-based material is also present on the outside of the channels 2, on at least one of the opposite faces 3, 4 of the panel 1 in which the channels 2 flow, where it forms at least one reinforcement layer 12.

The resin is spread without solution of continuity inside the channels 2, where it defines the structural stiffening elements, and outside of them, where it defines every reinforcement layer 12, and thereby it ensures substantial consolidation of the overall panel structure 1.

In order to allow them to be correctly impregnated and completely filled with resin, the channels 2, in the case in which they have a blind end (FIGS. 4 and 5), they are placed in communication with the outer surface of the panel 1 through at least one suitable calibrated outlet hole 6 for the resin itself.

The outlet holes 6 can extend on the extension of the channels 2, as shown, or else they can extend transversally to the channels and flow on a side face of the panel 1 other than the opposite faces 3, 4 that define its thickness. The resin can according to the application be of the thermoplastic and/or thermosetting type or any other type suitable for the purpose, for example resins known by the trade name “ISOPLAST” or “CYCLICS”.

The resin can also be reinforced with continuous fibres (FIGS. 1-5), loaded with discontinuous fibres 10 or fibres that are short compared to the length of the channels 2

In the case of reinforcement with continuous fibres, it is possible to foresee at least one first plurality of continuous fibres 9 that extend with one portion thereof in the structural stiffening elements 5 and with the remaining portion in one or each reinforcement layer 12, and a second plurality of continuous fibres that extends inside one or each reinforcement layer 12 (FIGS. 2 and 5).

The second plurality of continuous fibres can also be ordered in one or more piled up and directly associated layers 13, 14 of parallel continuous fibres in which each layer of fibres has its own orientation of the fibres.

In each reinforcement layer 12 the first plurality of fibres 9, and in particular the portion of the first plurality of fibres 9 present in the reinforcement layer 12, is directly associated with the second plurality of fibres.

Such direct associated is in the form of simple contact (FIGS. 2 and 3) between the inner layer 13 of the second plurality of fibres and the portion of the first plurality of fibres 9 emerging and levelled (for example in open order) on the face 3 and/or 4 of the panel 1, or else in woven form (FIG. 5) between the second plurality of fibres and the portion of the first plurality of fibres 9 emerging on the face 3 and/or 4 of the panel 1.

In both cases the association between the first fibres 13 and the second fibres 13, 14 promotes the consolidation of the overall structure and in addition also the resistance to delamination between each reinforcement layer 12 and the panel 1.

As an example the panel 1 is a sheet of PVC, expanded polyurethane or expanded phenolic resin, the resin used is thermosetting epoxy, phenolic or polyurethane resin, and the fibre used is glass.

The panel 1 can take up a substantially flat configuration (as shown) or else it can have an alveolar configuration suitable for flexibly adapting to surfaces of various profile, even curvilinear.

The process for making the panel structure 1, in the case in which the resin is to be reinforced with the first and second plurality 9 and 13, 14 of continuous fibres, consists of forming the channels 2, positioning and associating the first and second plurality of fibres 9 and 13, 14, impregnating the channels 2 and the first and second plurality of fibres 9 and 13, 14 with resin to constitute the structural stiffening elements 5 and each reinforcement layer 12, and carrying out the polymerisation and/or setting of the resin so as to consolidate and/or stiffen the structure.

The impregnation with resin can advantageously be carried out in a continuous pultrusion process, or else with a closed mould vacuum infusion process.

The channels 2 are formed by suitable perforators, for example needles, to which the fibres of the first plurality of fibres 9 are hooked to be pulled into the channels just as they are being made.

As stated, the second plurality of fibres 13, 14 is in the form of one or more of piled up layers.

The positioning of the first plurality of fibres 9 can be before or after that of the second plurality of fibres 13, 14. In the first case the first plurality of fibres 9 is associated by simple contact with the inner layer 13 of the second plurality of fibres, in the second case the fibres of the first plurality of fibres 9 interweave with the fibres of the second plurality of fibres as the perforators pass through the thickness of the layer or layers 13, 14 formed by the second plurality of fibres.

In the case in which the resin is to be reinforced with discontinuous fibres, firstly the fibres are positioned and then impregnation takes place preferably with a closed mould vacuum infusion process or a pressure injection process. Also in the case in which the resin is not to be reinforced the impregnation is preferably carried out with a closed mould vacuum infusion process or a pressure injection process.

The panel structure and the process for making it thus conceived can undergo numerous modifications and variations, all of which are covered by the inventive concept; moreover, all of the details can be replaced with technically equivalent elements.

whatever according to the requirements and the state of the art.

1. Panel structure, characterised in that through at least part or all of its thickness a plurality of channels extend in which there are structural stiffening elements comprising a resin-based material.

2. Panel structure according to one or more of the previous claims, characterised in that said channels flow on at least one of two opposite faces of said panel.

3. Panel structure according to claim 1, characterised in that said channels extend perpendicular to said opposite faces of said panel.

4. Panel structure according to claim 1, characterised in that said channels have an inclination or combination of different inclinations to allow said structural stiffening elements to be arranged according to a lattice design.

5. Panel structure according to one or more of the previous claims, characterised in that said resin is also present on the outside of said channels, on at least one of said opposite faces of said panel, where at least one reinforcement layer forms.

6. Panel structure according to one or more of the previous claims, characterised in that said resin is spread without solution of continuity inside said channels, where it defines said structural stiffening elements, and outside of them, where it defines said at least one reinforcement layer.

7. Panel structure according to one or more of the previous claims, characterised in that said resin is reinforced with continuous fibres.

8. Panel structure according to one or more of the previous claims, characterised in that said resin is loaded with discontinuous fibres.

9. Panel structure according to one or more of the previous claims, characterised in that said resin is not loaded with fibres.

10. Panel structure according to one or more of the previous claims, characterised in that said continuous fibres comprise at least one first plurality of continuous fibres that extend with a portion thereof in said structural stiffening elements and with the remaining portion in said at least one reinforcement layer, and a second plurality of continuous fibres that extends inside said at least one reinforcement layer.

11. Panel structure according to one or more of the previous claims, characterised in that said second plurality of continuous fibres is ordered in one or more piled up and directly associated layers of parallel continuous fibres in which each layer of parallel continuous fibres has its own orientation of the parallel continuous fibres.

12. Panel structure according to one or more of the previous claims, characterised in that the part of said first plurality of fibres present in said reinforcement layer is directly associated with said second plurality of fibres.

13. Panel structure according to one or more of the previous claims, characterised in that the part of said first plurality of fibres present in said reinforcement layer is in contact along a contact surface with said second plurality of fibres.

14. Panel structure according to one or more of the previous claims, characterised in that the portion of said first plurality of fibres present in said reinforcement layer is interwoven with said second plurality of fibres.

15. Panel structure according to one or more of the previous claims, characterised in that from each of said channels extends at least one calibrated outlet hole for said resin in communication with the outer surface of said panel.

16. Panel structure according to one or more of the previous claims, characterised in that said resin is thermoplastic.

17. Panel structure according to one or more of the previous claims, characterised in that said resin is thermosetting.

18. Panel structure according to one or more of the previous claims, characterised in that said channels are uniformly distributed on a defined part of said panel.

19. Panel structure according to one or more of the previous claims, characterised in that said channels are uniformly distributed on the entire panel.

20. Panel structure according to one or more of the previous claims, characterised in that said panel has an alveolar configuration suitable for adapting flexibly to variously shaped surfaces.

21. Process for making a panel structure, characterised in that it consists of forming a plurality of channels along a part or all of its thickness flowing on at least one face of said panel, positioning a portion of a first plurality of continuous fibres in said channels, directly associating the remaining portion with a second plurality of continuous fibres ordered in one or more piled up layers at said at least one face of said panel, impregnating said channels and said first and second plurality of fibres with a resin-based material, and carrying out the polymerisation and/or setting of said resin-based material so as to consolidate and stiffen said structure.

22. Process for making a panel structure according to the previous claim, characterised in that said association is carried out by simple contact along a mutual contact surface between said first and second plurality of continuous fibres.

23. Process for making a panel structure according to the previous claim, characterised in that said association is carried out by interweaving between said first and second plurality of continuous fibres.

24. Process for making a panel structure according to one or more of the previous claims, characterised in that said first plurality of fibres is positioned in said panel before said second plurality of fibres is positioned.

25. Process for making a panel structure according to one or more of the previous claims, characterised in that said first plurality of fibres is positioned in said panel after said second plurality of fibres is positioned.

26. Process for making a panel structure according to one or more of the previous claims, characterised in that said channels are formed by suitable perforators, for example needles, to which the fibres of said first plurality of fibres are hooked to be pulled into said channels just as they are being made.

27. Process for making a panel structure according to one or more of the previous claims, characterised in that said impregnation is carried out through a vacuum infusion system.

28. Process for making a panel structure according to one or more of the previous claims, characterised in that said impregnation is carried out in a continuous pultrusion process.
